(19) United States
(12) Patent Application Publication
(10) Pub. No.: US 2026/0067364 A1
(43) Pub. Date: Mar. 5, 2026

(54) APPARATUS AND METHOD FOR DIAGNOSTIC COMMUNICATION IN A VEHICLE AND A VEHICLE INCLUDING THE SAME

(71) Applicants: HYUNDAI MOTOR COMPANY, Seoul (KR); KIA CORPORATION, Seoul (KR)

(72) Inventor: Jae Hun Lee, Hwaseong-si (KR)

(73) Assignees: HYUNDAI MOTOR COMPANY, Seoul (KR); KIA CORPORATION, Seoul (KR)

(21) Appl. No.: 19/029,773

(22) Filed: Jan. 17, 2025

(30) Foreign Application Priority Data
Aug. 29, 2024 (KR) 10-2024-0116662

(51) Int. Cl. H04L 67/12; G07C 5/00

(52) U.S. Cl. CPC H04L 67/12; G07C 5/008

(57) ABSTRACT

A method for diagnostic communication in a vehicle includes performing a diagnostic server search procedure based on a first protocol when a predetermined diagnostic server search condition is satisfied by one of a plurality of communication nodes in the vehicle. The method also includes including, in a message, protocol support information corresponding to whether a plurality of protocols including the first protocol can be supported, according to the diagnostic server search procedure, by the one of a plurality of communication nodes. The method further includes transmitting the message.

### CROSS-REFERENCE TO RELATED APPLICATION(S)

This application claims the benefit of and priority to Korean Patent Application No. 10-2024-0116662 filed on Aug. 29, 2024, in the Korean Intellectual Property Office, the entire contents of which are hereby incorporated herein by reference.

### BACKGROUND

### 1. Field

The present disclosure relates to a method and an apparatus for diagnostic communication in a vehicle, and a vehicle including the same.

### 2. Description of Related Art

With the development of vehicle technology, vehicles may include various electronic control modules that may control various devices or systems mounted in vehicles. Examples of electronic control modules may include an engine control module (engine control unit, ECU), a transmission control module (transmission control unit, TCU), an airbag control module (airbag control unit, ACU), an antilock braking system (antilock braking system, ABS) module, a measuring instrument and driver information module, etc.

The electronic control modules may be connected through a vehicle network. The electric control modules may monitor various control inputs and operating parameters transmitted through the vehicle network and may control devices or systems accordingly. For example, an engine control module (ECM) may receive accelerator pedal depression as an input to control an ignition and fuel system of an engine. In addition, the engine control module (ECM) may monitor a speed, a torque, and other operating parameters of the engine, to optimize performance of the engine. Some control or operating parameters monitored by one module may be requested by one or more other modules. For example, an engine speed monitored by the engine control module may be requested by a transmission control module, a brake release module, and a measuring instrument and driver information module. Additionally, a wheel speed monitored by the antilock braking system module may be used by the engine control module and the transmission control module for traction control purposes.

Since the electronic control module may be disposed in the vehicle, a vehicle diagnostic device (e.g., an on-board diagnostics device) may communicate with the electronic control module via the vehicle network (e.g., Ethernet) according to a diagnostic communication protocol (e.g., diagnostics over internet protocol (DoIP)), to diagnose the electronic control module.

### SUMMARY

As the number of a plurality of electronic control modules mounted on a vehicle is gradually increasing, and types of the plurality of electronic control modules mounted on the vehicle are also gradually diversifying, a single protocol for diagnosing the electronic control modules may encounter limitations (e.g., network traffic problems, difficulty in blocking potential external attacks).

A method and an apparatus for diagnostic communication in a vehicle, and a vehicle including the same, according to an embodiment of the present disclosure, may provide a diagnostic environment capable of efficiently and stably utilizing a plurality of protocols for diagnosing an electronic control module.

According to an aspect of the present disclosure, a method for diagnostic communication in a vehicle is provided. The method includes an operation of performing a diagnostic server search procedure based on a first protocol after satisfying a predetermined diagnostic server search condition, by one of a plurality of communication nodes in the vehicle. The method also includes an operation of including protocol support information corresponding to whether a plurality of protocols including the first protocol can be supported, in a message according to the diagnostic server search procedure, by the one of a plurality of communication nodes, and transmitting the message.

According to another aspect of the present disclosure, an apparatus for diagnostic communication in a vehicle is provided. The apparatus includes an edge communication node receiving a message from an external source of the vehicle and a protocol converting or routing the message. The apparatus also includes a control communication node receiving the message protocol converted or routed by the edge communication node. At least one of the edge communication node or the control communication node is configured such that, after satisfying a predetermined diagnostic server search condition, a diagnostic server search procedure is performed based on a first protocol, and protocol support information corresponding to whether a plurality of protocols including the first protocol can be supported is included in a message according to the diagnostic server search procedure, and is transmitted.

According to another aspect of the present disclosure, a vehicle is provided. The vehicle includes a computing device having a processor and a storage medium storing one or more programs configured to be executable by the processor. The one or more programs include commands for executing the method for diagnostic communication in the vehicle.

### BRIEF DESCRIPTION OF DRAWINGS

The above and other aspects, features, and advantages of the present disclosure should become more apparent from the following detailed description, taken in conjunction with the accompanying drawings, in which:

FIG. 1 is a view illustrating a specific implementation of a method and an apparatus for diagnostic communication in a vehicle, according to an embodiment of the present disclosure, and the vehicle.

FIGS. 2A and 2B are block diagrams illustrating a plurality of nodes of a method and an apparatus for diagnostic communication in a vehicle, according to an embodiment of the present disclosure.

FIGS. 3A to 3D are views illustrating diagnostic server search conditions and diagnostic server search procedures of a method and an apparatus for diagnostic communication in a vehicle, according to an embodiment of the present disclosure.

FIG. 4 is a view illustrating protocol support information included in a message format according to a diagnostics over internet protocol (DoIP) of a method and an apparatus for diagnostic communication in a vehicle, according to an embodiment of the present disclosure.

FIGS. 5 and 6 are flowcharts illustrating a method for diagnostic communication in a vehicle, according to an embodiment of the present disclosure.

### DETAILED DESCRIPTION

Since the present disclosure may have various changes and may have various embodiments, specific embodiments are illustrated in the drawings and described in detail. However, this is not intended to limit the present disclosure to specific embodiments. Rather, it should be understood to include all modifications, equivalents, and substitutes included in the spirit and scope of the present disclosure.

Terms such as first, second, etc. may be used to describe various elements. However, the elements are not limited by the terms. The above terms may be used only for the purpose of distinguishing one component from another. For example, without departing from the scope of the present disclosure, a first component may be referred to as a second component, and similarly, a second component may also be referred to as a first component. The term “and/or” may include a combination of a plurality of related listed items or any of a plurality of related listed items.

The terms used in the present application may be only used to describe specific embodiments, and are not intended to limit the present disclosure. The singular expression may include the plural expression unless the context clearly dictates otherwise. In the present disclosure, terms such as “comprise,” “include,” “have,” and the like are intended to designate that a feature, a number, a step, an operation, a component, a part, or a combination thereof described in the specification exists, but it should be understood that the existence or addition of one or more other features, numbers, steps, operations, components, parts, or combinations thereof are excluded.

Unless defined otherwise, all terms used herein, including technical or scientific terms, have the same meaning as commonly understood by one of ordinary skill in the art to which the present disclosure pertains. Terms such as those defined in a commonly used dictionary should be interpreted as having a meaning consistent with the meaning in the context of the related art, and should not be interpreted in an ideal or excessively formal meaning unless explicitly defined in the present disclosure.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

When a component, device, unit, element, or the like of the present disclosure is described as having a purpose or performing an operation, function, or the like, the component, device, or element should be considered herein as being “configured to” meet that purpose or perform that operation or function.

In this specification, a vehicle (including an electric vehicle) means various vehicles that move a transport object such as a person, an animal, an object, or the like from a starting point to a destination. Such vehicles are not limited to vehicles that run on roads or tracks.

Hereinafter, with reference to the accompanying drawings, embodiments of the present disclosure are described in more detail.

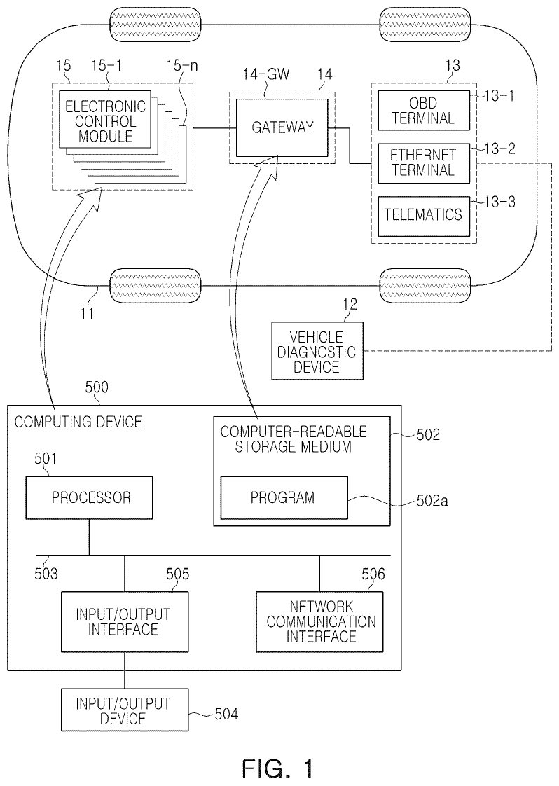

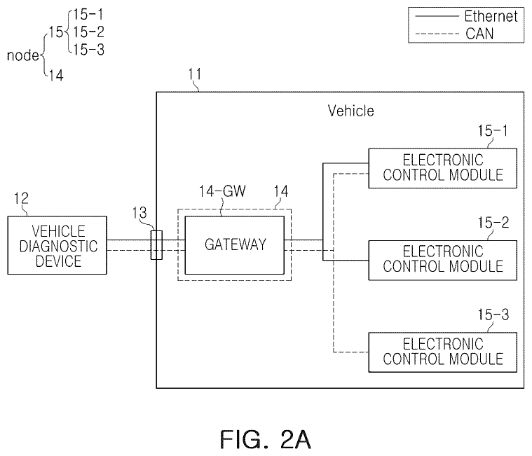

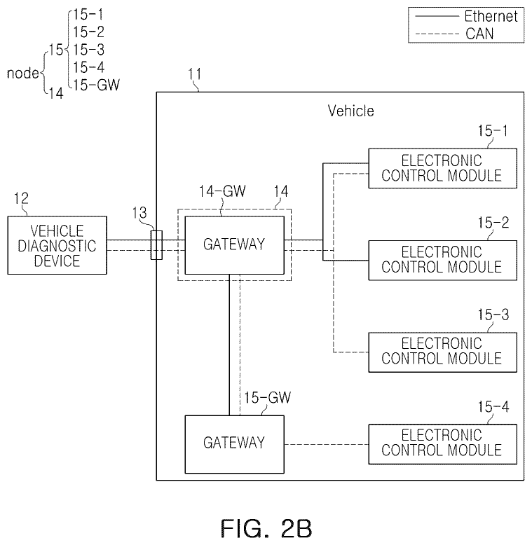

FIG. 1 is a view illustrating an example implementation of a method and an apparatus for diagnostic communication in a vehicle, according to an embodiment of the present disclosure, and the vehicle. Referring to FIG. 1 and FIGS. 2A and 2B, a vehicle 11 may include a plurality of electronic control modules 15-1-15-n configured to collect, provide, and transmit information necessary for driving, information required during driving, or information for enhancing driving safety to a user, a driver, or a passenger.

The plurality of electronic control modules 15-1-15-n may be connected to each other through a vehicle network to exchange data. The plurality of electronic control modules 15-1-15-n may include an information collection device such as a sensor, a camera, or the like, as well as an information collection device capable of generating and processing new information by performing calculations according to a preset program and a preset function, based on collected information, or the like.

In an example, each of the plurality of electronic control modules 15-1-15-n may be implemented as an electronic control unit (ECU) that controls various devices included in the vehicle. The ECU may be implemented, for example, as an ECU that controls an infotainment device (e.g., a display device, a navigation device, an around view monitoring device, or the like). As another example, the ECU may be implemented as an engine control unit, a transmission control unit, an engine management system electronic control unit (EMS ECU), a transmission management system electronic control unit (TMS ECU), an airbag control module (airbag control unit, ACU), an anti-locking brake system electronic control unit (ABS ECU), or a measuring instrument and driver information module.

The plurality of electronic control modules 15-1-15-n may be connected to each other through a hierarchical network structure via an edge gateway 14-GW. The edge gateway 14-GW may include a computer or a software that enables communication between networks using different communication networks and protocols in a vehicle network. The edge gateway 14-GW may be a network point that acts as an entrance to different networks. The edge gateway 14-GW may also act as a passage between different types of networks.

The vehicle 11 may include one or more edge gateways 14-GW. The number of edge gateways 14-GW included in the vehicle 11 may be determined in accordance with the number and connection type of the plurality of electronic control modules 15-1-15-n mounted on the vehicle.

A vehicle diagnostic device 12 for diagnosing the plurality of electronic control modules 15-1-15-n mounted on the vehicle 11 may be connected to or interlocked with the vehicle 11. The vehicle diagnostic device 12 may diagnose the plurality of electronic control modules 15-1-15-n connected through a plurality of different communication methods of vehicle network. The vehicle diagnostic device 12 may be in the form of a terminal device that may be physically separated from the vehicle but may be connected through terminals mounted on the vehicle. In addition, according to an embodiment, the vehicle diagnostic device 12 may be in the form of a network server that may check the plurality of electronic control modules 15-1-15-n mounted on the vehicle and may collect data through a wired/wireless communication network.

There may be an input/output means 13 between the vehicle diagnostic device 12 and the edge gateway 14-GW that transmits data to perform a diagnostic process and to collect results therefrom. For example, the input/output means 13 may include an on-board diagnostics (OBD) terminal 13-1 mounted on the vehicle. According to an embodiment, on-board diagnostics (OBD) refers to a diagnostic standard for checking and controlling an electrical/electronic operation status of the vehicle 11. Initially, it was used to improve maintenance efficiency of electronic components such as an engine or the like, but in addition to this purpose, OBD also serves as an interface as a trip computer that shows various vehicle information to the driver.

As the number of plurality of electronic control modules 15-1-15-n mounted on the vehicle 11 increases, and an amount of data transmitted and received by the plurality of electronic control modules 15-1-15-n increases, both controller area network (CAN) communication and Ethernet communication may be applied to the vehicle network. For example, a maximum transmission bandwidth of CAN communication, which may be a controller area network, may be 1 Mbps. At this speed, when the number of plurality of electronic control modules 15-1-15-n in the vehicle 11 increases, and data traffic increases rapidly due to real-time video transmission (e.g., Topview monitoring) or the like, there may be limitations in configuring the vehicle network using only CAN communication. A data transmission rate of CAN-FD may be up to 2 Mbit/s in a multi-drop network and up to 5 Mbit/s in point-to-point communication, and in Ethernet, a speed of 1 Gbps may be provided. Therefore, in a process of checking and controlling the electrical/electronic operation status of the vehicle 11, the vehicle diagnostic device 12 may be connected via an Ethernet terminal 13-2.

Depending on a design, the input/output means 13 may use a telematics device 13-3 mounted on the vehicle 11. The telematics device 13-3 may be an example of a device that may provide comprehensive multimedia services for vehicles using location information and wireless communication networks. The telematics device 13-3 may provide safe driving, emergency rescue, traffic information services, or the like to the driver. The telematics device 13-3 may also provide infotainment services such as the Internet, movies, games, and multimedia to the passenger. In addition, the telematics device 13-3 may transmit a diagnostic message for checking and collecting data from the plurality of electronic control modules 15-1-15-n mounted on the vehicle by linking with a network server for diagnosing the operation of devices in the vehicle. The telematics device 13-3 may transmit the data transmitted from the plurality of electronic control modules 15-1-15-n mounted on the vehicle to the network server.

The diagnostic message that may be transmitted through the edge gateway 14-GW may be transmitted through a user datagram protocol (UDP) and/or a transmission control protocol (TCP) among transport layer protocols. For example, for vehicle diagnosis (diagnostic access), a diagnostic protocol (e.g., diagnostics over IP, DoIP) based on IEEE802.3 and IPv4/IPv6 may be used, and a diagnostic protocol (e.g., diagnostics over CAN, DoCAN) based on CAN may be used.

A system for vehicle diagnosis may include at least one of a message generator that generates a diagnostic message for diagnosing the plurality of electronic control modules 15-1-15-n mounted on the vehicle, or a message receiver that recognizes the diagnostic message. The message generator and/or the message receiver may be included in each of the plurality of electronic control modules 15-1-15-n, the vehicle diagnostic device 12, and the edge gateway 14-GW.

The plurality of electronic control modules 15-1-15-n may communicate with devices connected to other vehicle networks via the edge gateway 14-GW. The edge gateway 14-GW may perform a switching role for the plurality of vehicle networks. The edge gateway 14-GW may be an interface between the plurality of electronic control modules 15-1-15-n. For example, the edge gateway 14-GW that transmits messages and signals according to a diagnostic protocol (e.g., DoIP, DoCAN) for networking with the vehicle diagnostic device 12 based on Ethernet/IP may provide scheduling and protocol conversion functions for interworking with the plurality of electronic control modules 15-1-15-n.

In an example, a plurality of communication nodes forming the vehicle network may be connected as a star topology, a bus topology, a ring topology, a tree topology, a mesh topology, or the like. However, the present disclosure is not limited thereto. In an example, each of the plurality of communication nodes forming the vehicle network may support a CAN protocol, a FlexRay protocol, a MOST protocol, a LIN protocol, an Ethernet protocol, or the like. However, the present disclosure is not limited thereto.

In an example, each of the plurality of communication nodes may include layers 1 to 7. The layer 1 may support a PHY function and may support a transmission speed of 100 Mbps (megabit per second). The layer 2 may support an IEEE 802.1Q protocol, an IEEE 802.1p protocol, an IEEE 802.3 protocol, an audio video bridging (AVB) protocol (e.g., IEEE 802.1Qav protocol, IEEE 802.1Qat protocol), or the like. The layer 3 may support an internet protocol version 4 (IPv4), an address resolution protocol (ARP), an internet control message protocol version 4 (ICMPv4), IEEE 802.1AS, IEEE 1722, or the like. The layer 4 may support a transfer control protocol (TCP), a user datagram protocol (UDP), IEEE 802.1AS, IEEE 1722, or the like. The layers 5 to 7 may support a diagnostics over internet protocol (DoIP), a diagnostics over CAN (DoCAN), an EthCC protocol, a dynamic host configuration protocol (DHCP), an SD protocol, a network management (NM) protocol, IEEE 802.1AS, IEEE 1722, or the like.

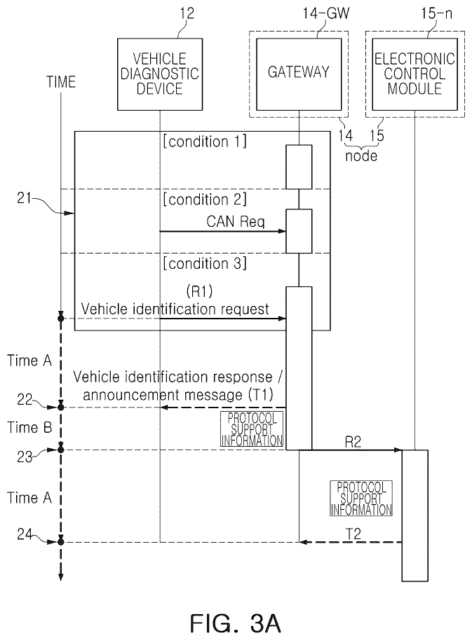

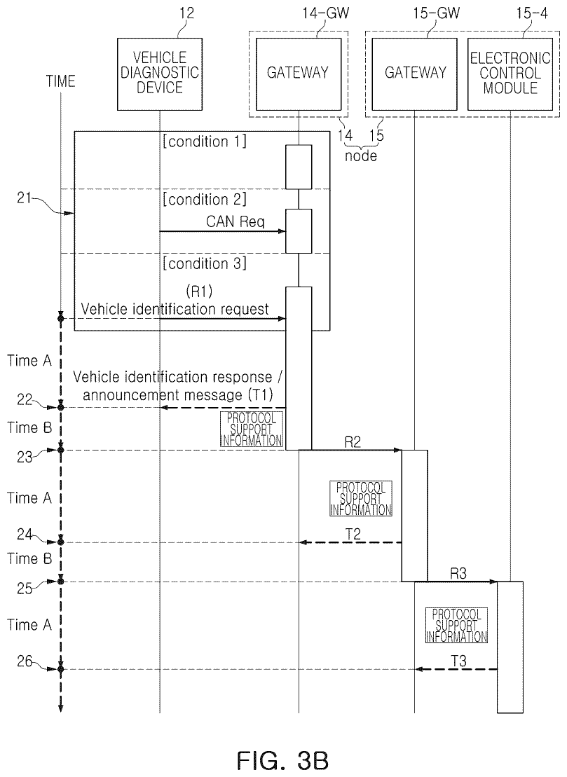

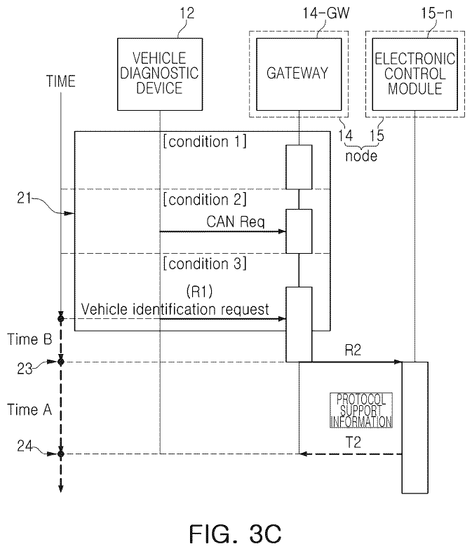

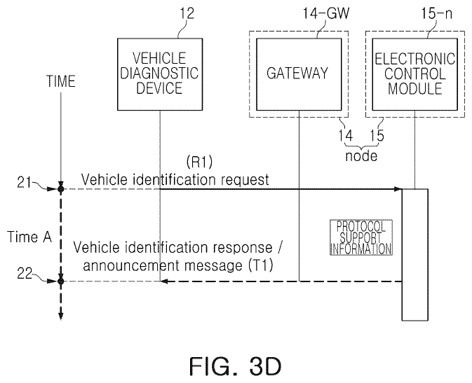

FIGS. 2A and 2B are block diagrams illustrating a plurality of nodes of a method and an apparatus for diagnostic communication in a vehicle, according to an embodiment of the present disclosure. FIGS. 3A to 3D are views illustrating diagnostic server search conditions and diagnostic server search procedures of a method and an apparatus for diagnostic communication in a vehicle, according to an embodiment of the present disclosure. FIG. 5 is a flowchart illustrating a method for diagnostic communication in a vehicle, according to an embodiment of the present disclosure.

Referring to FIGS. 2A to 3D, the plurality of communication nodes may include an edge communication node 14 and a control communication node 15. The edge communication node 14 may include an edge gateway 14-GW. The control communication node 15 may include a plurality of electronic control modules 15-1, 15-2, 15-3, and 15-4. Referring to FIGS. 2B and 3B, the control communication node 15 may further include a control gateway 15-GW.

An apparatus for diagnostic communication in a vehicle, according to an embodiment of the present disclosure, may include an edge communication node 14 that receives a message from an external source of the vehicle (e.g., vehicle diagnostic device 12) and protocol-converts or routes the message. The apparatus may also include a control communication node 15 that receives a message protocol-converted or routed by the edge communication node 14. For example, an edge gateway 14-GW of the edge communication node 14 may perform protocol conversion between a first protocol (e.g., Ethernet, DoIP) and a second protocol (e.g., CAN, DoCAN) for the message transmitted and received between the vehicle diagnostic device 12 and the control communication node 15, or may perform simple routing without protocol conversion.

Since various types of a plurality of electronic control modules 15-1-15-n may be provided, and the number of the plurality of electronic control modules 15-1-15-n may be large, types/number of communications that may be respectively supported by the electronic control modules 15-1, 15-2, 15-3, and 15-4 may be different from each other, and types/number of protocols that may be supported may also be different from each other. For example, the electronic control module 15-1 and a control gateway 15-GW may support both Ethernet communication and CAN communication, and may support both a diagnostics over internet protocol (DoIP) based on Ethernet and a diagnostics over CAN (DoCAN) based on CAN. The electronic control module 15-2 may support only the Ethernet communication among the Ethernet communication and the CAN communication, and may support only DoIP among the DoIP and the DoCAN. Electronic control modules 15-3 and 15-4 may support only the CAN communication among the Ethernet communication and the CAN communication, and may support only the DoCAN among the DoIP and the DoCAN.

Depending on a design, a plurality of protocols may be based on not only the Ethernet and the CAN, but also a CAN with flexible data-rate (CAN-FD), local interconnect network (LIN) communication, media oriented systems transport (MOST) communication, or the like, and may be replaced by the CAN-FD, the LIN communication, the MOST communication. However, the present disclosure is not limited thereto.

Since an external source of the vehicle 11 (e.g., vehicle diagnostic device 12) may be connected to other vehicles as well as the vehicle 11, from perspective of the external source of the vehicle 11 (e.g., vehicle diagnostic device 12), type/number information of the plurality of electronic control modules 15-1-15-n in the vehicle 11 may be uncertain information. In addition, the type/number information of the plurality of electronic control modules 15-1-15-n in the vehicle 11 may change over time due to a change in setting, maintenance, tuning, or the like of the vehicle 11. Therefore, the external source of the vehicle 11 (e.g., vehicle diagnostic device 12) may frequently execute a diagnostic server search procedure to determine the type/number information of the plurality of electronic control modules 15-1-15-n in the vehicle 11. A plurality of communication nodes may be a diagnostic target of the vehicle diagnostic device 12, respectively, and may thus be diagnostic servers that receive diagnostic messages and transmit messages from perspective of the vehicle diagnostic device 12. After the diagnostic server search procedure, the external source of the vehicle 11 (e.g., vehicle diagnostic device 12) may efficiently diagnose at least some of the plurality of electronic control modules 15-1-15-n by utilizing the type/number information of the plurality of electronic control modules 15-1-15-n in the vehicle 11.

Referring to FIGS. 2A, 3A, and 5, a method and an apparatus for diagnostic communication in a vehicle, according to an embodiment of the present disclosure, may include or perform an operation S12 of performing a diagnostic server search procedure based on a first protocol (e.g., Ethernet, DoIP) when (e.g., after) a predetermined diagnostic server search condition 21 is satisfied in an operation S11, by one of a plurality of communication nodes in the vehicle. The method and the apparatus may also include or perform an operation S13 of generating protocol support information corresponding to whether a plurality of protocols (e.g., Ethernet, CAN, DoIP, DoCAN) including the first protocol can be supported, by the one of a plurality of communication nodes that satisfy the predetermined diagnostic server search condition 21 in the operation S12, and of including the protocol support information in a message (T1 and T2) according to the diagnostic server search procedure, and transmitting the message.

Therefore, an external source of the vehicle (e.g., vehicle diagnostic device 12) may know, through the diagnostic server search procedure, not only type/number information of a plurality of electronic control modules 15-1-15-n in the vehicle 11, but also protocol support information of the plurality of electronic control modules 15-1-15-n and/or protocol support information of an edge communication node 14. The external source of the vehicle (e.g., vehicle diagnostic device 12) may thus stably diagnose at least a portion of the plurality of electronic control modules 15-1-15-n by utilizing the protocol support information.

For example, while a temporary communication failure of a first protocol (e.g., Ethernet, DoIP) occurs, an external source of the vehicle (e.g., vehicle diagnostic device 12) may identify an electronic control module (15-1, 15-3, and 15-4) that may support a second protocol (e.g., CAN, DoCAN) based on the protocol support information, and may transmit a diagnostic message to the identified electronic control module (15-1, 15-3, and 15-4).

For example, an external source of the vehicle (e.g., vehicle diagnostic device 12) may identify an electronic control module 15-1 that may support both a first protocol (e.g., Ethernet, DoIP) and a second protocol (e.g., CAN, DoCAN), and may select one of the first and second protocols, based on an amount of communication data of the identified electronic control module 15-1 or protocol conversion load of the edge communication node 14.

In an example, when an external environment of the vehicle is an environment that requires communication security, an external source of the vehicle (e.g., vehicle diagnostic device 12) may group electronic control modules 15-1 and 15-2 that may support a first protocol (e.g., Ethernet, DoIP) based on the protocol support information, may group electronic control modules 15-1, 15-3, and 15-4 that may support a second protocol (e.g., CAN, DoCAN), and may operate a diagnostic schedule in units of a plurality of groups.

In this manner, a method and an apparatus for diagnostic communication in a vehicle, according to embodiments of the present disclosure, may provide an environment in which diagnostic communication may be flexibly performed for the plurality of electronic control modules 15-1, 15-2, 15-3, and 15-4 of which supportable types/numbers of communications are different from each other.

In an example, the predetermined diagnostic server search condition 21 may comprise a plurality of diagnostic server search conditions 21 including at least two of the followings: a first condition [condition 1] in which at least one of the plurality of communication nodes is changed from a power-off state to a power-on state, or at least one of the plurality of communication nodes is physically disconnected; a second condition [condition 2] in which the edge communication node 14 receives a message according to a second protocol (e.g., CAN, DoCAN) from an external source of the vehicle (e.g., vehicle diagnostic device 12); and a third condition [condition 3] in which the edge communication node 14 receives a first vehicle identification request R1 from an external source of the vehicle (e.g., vehicle diagnostic device 12). The operation S12 of FIG. 5 may include performing the diagnostic server search procedure when (e.g., after) at least one of the plurality of diagnostic server search conditions 21 is satisfied in the operation S11 of FIG. 5.

The first condition [condition 1] may be a condition for changing type/number information of the plurality of electronic control modules 15-1-15-n in the vehicle 11. The first condition [condition 1] may thus be a condition for need for an external source of the vehicle (e.g., vehicle diagnostic device 12) to identify the information. The second condition [condition 2] may be a condition for the external source of the vehicle (e.g., vehicle diagnostic device 12) to support both the first and second protocols. The third condition [condition 3] may be a condition for the diagnostic server search procedure that may be first executed in the external source of the vehicle (e.g., vehicle diagnostic device 12) to be propagated to the plurality of communication nodes. The second condition and the third condition may be conditions for the need for the external source of the vehicle (e.g., vehicle diagnostic device 12) to utilize protocol support information.

The operation S12 of FIG. 5 may include, when (e.g., after) the predetermined diagnostic server search condition 21 is satisfied in the operation S11 of FIG. 5 or after receiving the first vehicle identification request R1, by the edge communication node 14, transmitting a message T1 to an external source of the vehicle (e.g., vehicle diagnostic device 12) at a time point 22, and then transmitting a second vehicle identification request R2 to the control communication node 15 at a time point 23. Therefore, even when the external source of the vehicle (e.g., vehicle diagnostic device 12) transmits the first vehicle identification request R1 only to the edge communication node 14, the second vehicle identification request R2 may be transmitted to the control communication node 15. For example, the message T1 may be implemented as a vehicle identification response and/or a vehicle announcement message, and it may be known that the first vehicle identification request R1 is properly transmitted to the edge communication node 14 by receiving the message T1 by the external source of the vehicle (e.g., vehicle diagnostic device 12).

In an example, a time difference between a time point of receiving the first vehicle identification request R1 and the time point 22 of transmitting the message T1 may be within a predetermined first time (Time A). Also, a time difference between the time point 22 of transmitting the message T1 and the time point 23 of transmitting the second vehicle identification request R2 may be within a predetermined second time (Time B).

For example, the first time (Time A) may be selected within a range exceeding 0 seconds and less than or equal to 500 milliseconds (ms), and may be defined as an announcement wait of DoIP, but is not limited thereto. For example, the second time (Time B) may be selected within a range of 0 seconds to 50 ms, and may be defined as an identification wait of DoIP, but is not limited thereto.

The operation S13 of FIG. 5 may include, after receiving the second vehicle identification request R2 by the control communication node 15, including the protocol support information of the control communication node 15 in a message T2 according to the diagnostic server search procedure, and transmitting the message T2 to the edge communication node 14, at a time point 24 within a predetermined first time (Time A). The edge communication node 14 may route the message T2 to the external source of the vehicle (e.g., vehicle diagnostic device 12). The external source of the vehicle (e.g., vehicle diagnostic device 12) may identify the electronic control module 15-n and may also learn the protocol support information of the electronic control module 15-n. The method of the message T2 may be similar to the method of the message T1. However, the present disclosure is not limited thereto.

Depending on a design, the operation S13 of FIG. 5 may include transmitting the message T1 including the protocol support information of the edge communication node 14 to the external source of the vehicle (e.g., vehicle diagnostic device 12) within the predetermined first time (Time A), after receiving the first vehicle identification request R1 by the edge communication node 14. Therefore, the external source of the vehicle (e.g., vehicle diagnostic device 12) may identify the edge communication node 14 and may also learn the protocol support information of the edge communication node 14.

Referring to FIGS. 2B and 3B, a control communication node 15 may include a control gateway 15-GW and an electronic control module 15-n. The control gateway 15-GW may perform protocol conversion or routing for messages transmitted and received between an edge communication node 14 and the electronic control module 15-n.

The operation S13 of FIG. 5 may include transmitting a third vehicle identification request R3 to the electronic control module 15-n by the control gateway 15-GW. The operation S13 of FIG. 5 may include, after receiving the third vehicle identification request R3 by the electronic control module 15-n, including protocol support information of the electronic control module 15-n in a message T3 according to a diagnostic server search procedure and transmitting the message T3 to the control gateway 15-GW, at a time point 26 within a predetermined first time (Time A). Therefore, even when an external source of a vehicle (e.g., vehicle diagnostic device 12) transmits the first vehicle identification request R1 only to the edge communication node 14, second and third vehicle identification requests R2 and R3 may be sequentially transmitted to the control gateway 15-GW and the electronic control module 15-n. The message T3 may be routed to the external source of the vehicle (e.g., vehicle diagnostic device 12) through the control gateway 15-GW and the edge communication node 14.

In an example, the operation S13 of FIG. 5 may further include, after receiving a second vehicle identification request R2 from the edge communication node 14 by the control gateway 15-GW, including protocol support information of the control gateway 15-GW in a message T2 according to the diagnostic server search procedure, and transmitting the message T2 to the edge communication node 14 at a time point 24. The control gateway 15-GW may transmit, after transmitting to the edge communication node 14, a third vehicle identification request R3 to the electronic control module 15-n at a time point 25 within a predetermined second time (Time B). The message T2 may be routed to the external source of the vehicle (e.g., vehicle diagnostic device 12) via the edge communication node 14.

Depending on a design, the messages T1, T2, and T3 may be implemented as at least one of a vehicle identification response or a vehicle announcement message, as well as routing activation, alive check, a DoIP entity status, diagnostic power mode information, or a diagnostic message.

Referring to FIG. 3C, depending on a design, an edge communication node 14 may receive a first vehicle identification request R1, and may transmit a second vehicle identification request R2 to a control communication node 15, without transmitting a message to an external source of a vehicle (e.g., vehicle diagnostic device 12). Thereafter, at a time point 24, the control communication node 15 may include protocol support information of the control communication node 15 in a message T2 according to a diagnostic server search procedure, and may transmit the message T2 to the edge communication node 14. The edge communication node 14 may route the message T2 to the external source of the vehicle (e.g., vehicle diagnostic device 12). The external source of the vehicle (e.g., vehicle diagnostic device 12) may learn that the first vehicle identification request R1 is properly transmitted to the edge communication node 14 by receiving the message T2. Also, the external source of the vehicle (e.g., vehicle diagnostic device 12) may identify the control communication node 15, and may learn the protocol support information of the control communication node 15.

Referring to FIG. 3D, depending on a design, a control communication node 15 may receive a first vehicle identification request R1 from an external source of a vehicle (e.g., vehicle diagnostic device 12) by bypassing an edge communication node 14, and may transmit a message T1 to the external source of the vehicle (e.g., vehicle diagnostic device 12) by bypassing the edge communication node 14. Therefore, the external source of the vehicle (e.g., vehicle diagnostic device 12) may directly diagnose the control communication node 15.

For example, the first vehicle identification request R1 of FIGS. 3A and 3B may be a unicast message in which a target is the edge communication node 14, or a broadcast message in which a target is not set. The first vehicle identification request R1 of FIGS. 3C and 3D may be a unicast message in which a target is the control communication node 15. The edge communication node 14 of FIG. 3C may propagate the second vehicle identification request R2 according to the first vehicle identification request R1. The edge communication node 14 of FIG. 3D may not be involved in the first vehicle identification request R1. The edge communication node 14 may receive the first vehicle identification request R1 and may transmit the first vehicle identification request R1, as is, to the control communication node 15.

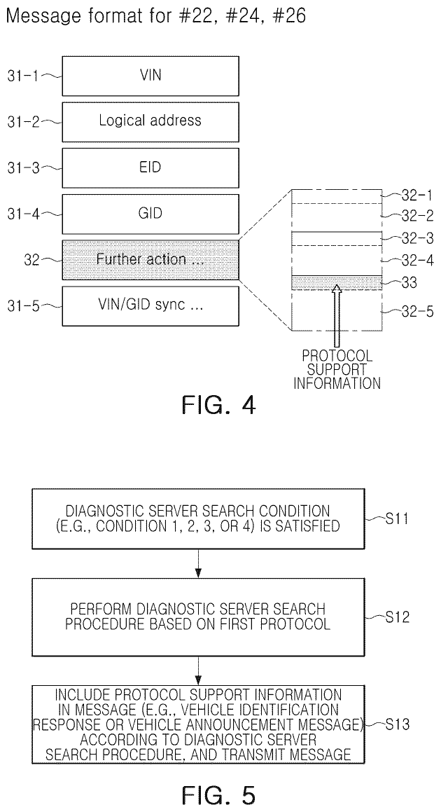

FIG. 4 is a drawing illustrating protocol support information included in a message format according to a diagnostics over internet protocol (DoIP) of a method and an apparatus for diagnostic communication in a vehicle, according to an embodiment of the present disclosure. Referring to FIG. 4, a payload of a message format according to a diagnostics over internet protocol (DoIP) may include a VIN 31-1, a logical address 31-2, an EID 31-3, a GID 31-4, a further action 32, and a VIN/GID sync 31-5.

The VIN 31-1 may be a vehicle identity (ID) consisting of 17 characters defined in ISO 3779. The logical address 31-2 may be an address of a responding electronic control module. The EID 31-3 may be a unique identity (ID) of the responding electronic control module. The GID 31-4 may be a unique group identity (ID) to which the responding electronic control module belongs. The VIN/GID sync 31-5 may be information on whether a VIN/GID synchronization process in a vehicle is completed. The further action 32 may include information additionally required for connection by the responding electronic control module.

The operation S13 of FIG. 5 may include transmitting a message that includes protocol support information in the further action 32 of a message format according to DoIP. For example, the protocol support information may include first protocol support information indicating that both the first and second protocols may be supported and second protocol support information indicating that only the first protocol (e.g., Ethernet, DoIP) among the first and second protocols may be supported.

In an example, among defined sections 32-1, 32-2, 32-3, 32-4, 33, and 32-5 of the further action 32, a value of the section 33 including the protocol support information may be selected from one of 0x00, 0x10, or 0x20. The 0x00 may mean that the first protocol support information is included without any further request action, the 0x10 may mean that a specific security procedure is required before connection, and the 0x20 may mean that the second protocol support information is included without any further request action. According to a design, the value of the section 33 may be selected as one of a number of cases (e.g., 0x30, 0x40). Some of the cases may mean that only the second protocol (e.g., CAN, DoCAN) may be supported, and other cases may mean a specific security procedure and other types of additional required information.

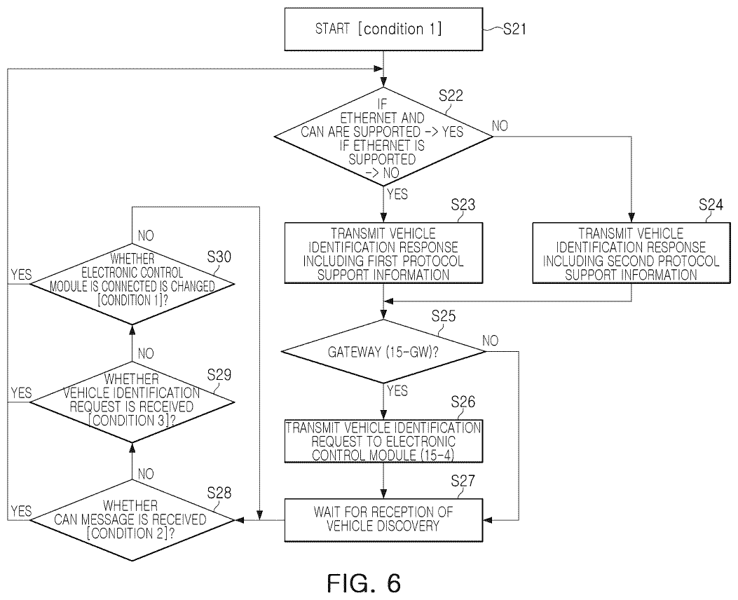

FIG. 6 is a flowchart illustrating a method for diagnostic communication in a vehicle, according to an embodiment of the present disclosure. Referring to FIGS. 2B, 3B, and 6, after starting (corresponding to the first condition [condition 1]) in an operation S21 (e.g., when at least one of a plurality of communication nodes is changed from a power-off state to a power-on state), at least one of the plurality of communication nodes may, in an operation S22, check whether a first protocol (e.g., Ethernet) and a second protocol (e.g., CAN) can be supported.

In an operation S23, at least one of the plurality of communication nodes may transmit a vehicle identification response (e.g., one of the messages T1, T2, and T3 of FIG. 3B) including first protocol support information when both the first protocol (e.g., Ethernet) and the second protocol (e.g., CAN) can be supported. In an operation S24, the at least one of the plurality of communication nodes may transmit a vehicle identification response (e.g., one of the messages T1, T2, and T3 of FIG. 3B) including second protocol support information when only the first protocol (e.g., Ethernet) can be supported.

In an operation S26, the at least one of the plurality of communication nodes may selectively transmit a vehicle identification request (e.g., R2 or R3 of FIG. 3B) to an electronic control module 15-4, depending on whether the at least one of the plurality of communication nodes is a control gateway 15-GW according to a determination in an operation S25, or may wait for reception of vehicle discovery from an external source of the vehicle (e.g., vehicle diagnostic device 12) in an operation S27. For example, an external device of the vehicle (e.g., vehicle diagnostic device 12) may define information that a diagnostic server search procedure has completed, as vehicle discovery, and may transmit the information to at least one of the plurality of communication nodes.

Thereafter, when the at least one of the plurality of communication nodes satisfies at least one of the following conditions: a second condition [condition 2] in which an edge communication node 14 receives a message according to the second protocol (e.g., CAN, DoCAN) from the external source of the vehicle (e.g., vehicle diagnostic device 12) in an operation S28; a third condition [condition 3] in which the edge communication node 14 receives a first vehicle identification request R1 from the external source of the vehicle (e.g., vehicle diagnostic device 12) in an operation S29; or a first condition [condition 1] changing whether the electronic control module is connected (e.g., released) in an operation S30, the operation S12 of FIG. 5 and the operation S13 of FIG. 5 may be re-executed.

Referring to FIG. 1, the vehicle 11 according to an embodiment of the present disclosure may include a computing device 500 having a processor 501 and a storage medium 502 storing one or more programs 502a configured executable by the processor 501. The one or more programs 502a may include commands for executing a method for diagnostic communication in a vehicle, according to an embodiment of the present disclosure.

The computing device 500 may include at least one processor 501, a computer-readable storage medium 502, and a communication bus 503. The communication bus 503 may interconnect various other components of the computing device 500, including the processor 501 and the computer-readable storage medium 502. For example, the computing device 500 may be implemented as a microcontroller.

The processor 501 may cause the computing device 500 to operate according to the example embodiment mentioned above. For example, the processor 501 may execute one or more programs stored on the computer-readable storage medium 502. The one or more programs may include one or more computer-executable commands, which, when executed by the processor 501, and may be configured to cause the computing device 500 to perform operations according to the example embodiments.

The computer-readable storage medium 502 may be configured to store a computer-executable command, a program code, a program data, and/or other suitable forms of information. A program 502a stored on the computer-readable storage medium 502 may include a set of instructions executable by the processor 501. In an embodiment, the computer-readable storage medium 502 may be a memory (volatile memory, such as random access memory, nonvolatile memory, or a suitable combination thereof), one or more magnetic disk storage devices, optical disk storage devices, flash memory devices, or any other form of storage medium that may be accessed by the computing device 500 and capable of storing desired information, or a suitable combination thereof.

The computing device 500 may also include one or more input/output interfaces 505 that provide interfaces for one or more input/output devices 504 and one or more network communication interfaces 506. The input/output interfaces 505 and the network communication interfaces 506 may be connected to the communication bus 503. The network may be any one of a cellular network, such as a global system for mobile communications (GSM), an enhanced data rates for GSM evolution (EDGE), a general packet radio service (GPRS), a code division multiple access (CDMA), a time division-CDMA (TD-CDMA), a universal mobile telecommunications system (UMTS), a long term evolution (LTE), a 5G, a Wi-Fi, or another cellular network, and may also be implemented as Ethernet, media oriented systems transport (MOST), Flexray, a controller area network (CAN), a local interconnect network (LIN), the Internet, Bluetooth®, a near field Communication (NFC), Zigbee®, Radio Frequency (RF), or the like.

The input/output device 504 may be connected to other components of the computing device 500 via the input/output interface 505. Examples of the input/output devices 504 may include an input device such as a pointing device (such as a mouse, a trackpad, or the like), a keyboard, a touch input device (such as a touchpad, a touchscreen, or the like), a voice or sound input device, various types of sensor devices and/or photographing devices, and/or an output device such as a display device, a printer, a speaker, and/or a network card. Examples of the input/output devices 504 may be included in the computing device 500 as a component constituting the computing device 500, or may be connected to the computing device 500 as a separate device distinct from the computing device 500.

Embodiments of the present disclosure may include a program for performing the methods described herein on a computer, and a computer-readable recording medium including the program. The computer-readable recording medium may include a program command, a local data file, a local data structure, or the like, alone or in combination. The medium may be specially designed and configured for the present disclosure, or may be commonly used in the field of computer software. Examples of the computer-readable recording medium may include a magnetic medium such as a hard disk, a floppy disk, and a magnetic tape, an optical recording medium such as a CD-ROM or a DVD, and a hardware device specifically configured to store and execute program commands such as a ROM, a RAM, a flash memory. Examples of the programs may include not only machine language codes such as those generated by a compiler, but also high-level language codes that may be executed by the computer using an interpreter, or the like.

A method and an apparatus for diagnostic communication in a vehicle, and the vehicle including the same, according to embodiments of the present disclosure, may provide a diagnostic environment capable of efficiently and stably utilizing a plurality of protocols for diagnosing an electronic control module.

For example, a method and an apparatus for diagnostic communication in a vehicle, and the vehicle including the same, according to embodiments of the present disclosure, may efficiently and stably overcome limitations (e.g., network traffic problems, difficulty in blocking potential external attacks) by a single protocol, may improve clarity of operation of communication nodes for flexible utilization of a plurality of protocols, and may reduce burden of a software change or a database update due to replacement of a portion of electronic control modules.

While example embodiments have been shown and described above, it should be apparent to those having ordinary skill in the art that modifications and variations could be made without departing from the scope of the present disclosure as defined by the appended claims.

What is claimed is:

1. A method for diagnostic communication in a vehicle, the method comprising:
performing a diagnostic server search procedure based on a first protocol when a predetermined diagnostic server search condition is satisfied by one of a plurality of communication nodes in the vehicle;
including, in a message, protocol support information corresponding to whether a plurality of protocols including the first protocol can be supported, according to the diagnostic server search procedure, by the one of the plurality of communication nodes; and
transmitting the message.

2. The method of claim 1, wherein the predetermined diagnostic server search condition includes a plurality of diagnostic server search conditions including at least two of:
a first condition in which at least one of the plurality of communication nodes is changed from a power-off state to a power-on state, or at least one of the plurality of communication nodes is physically disconnected;
a second condition in which an edge communication node, among the plurality of communication nodes, receives a message according to a second protocol among the plurality of protocols from an external source of the vehicle; and
a third condition in which the edge communication node receives a first vehicle identification request from an external source of the vehicle, and
wherein the diagnostic server search procedure is performed when at least one of the plurality of diagnostic server search conditions is satisfied by one of the plurality of communication nodes in the vehicle.

3. The method of claim 1, wherein the predetermined diagnostic server search condition comprises changing at least one of the plurality of communication nodes from a power-off state to a power-on state, or physically disconnecting at least one of the plurality of communication nodes.

4. The method of claim 1, wherein the predetermined diagnostic server search condition comprises receiving a message according to a second protocol among the plurality of protocols from an external source of the vehicle by an edge communication node among the plurality of communication nodes.

5. The method of claim 4, wherein:
the first protocol is based on Ethernet; and
the second protocol is based on controller area network (CAN).

6. The method of claim 1, wherein the predetermined diagnostic server search condition comprises receiving a first vehicle identification request from an external source of the vehicle by an edge communication node, among the plurality of communication nodes.

7. The method of claim 6, wherein:
performing the diagnostic server search procedure includes, after receiving the first vehicle identification request,
transmitting, by the edge communication node, a message to an external source of the vehicle, and
transmitting, by the edge communication node, a second vehicle identification request to a control communication node among the plurality of communication nodes; and
transmitting the message includes, after receiving the second vehicle identification request,
including, by the control communication node, protocol support information of the control communication node in a message according to the diagnostic server search procedure, and
transmitting the message of the control communication node to the edge communication node, within a predetermined first time.

8. The method of claim 6, wherein:
transmitting the message includes, after receiving the first vehicle identification request, transmitting, by the edge communication node, a message including protocol support information of the edge communication node to an external source of the vehicle within a predetermined first time; and
the method further includes, after transmitting the message of the edge communication node to the external source of the vehicle, transmitting, by the edge communication node, a second vehicle identification request to a control communication node among the plurality of communication nodes within a predetermined second time.

9. The method of claim 1, wherein:
performing the diagnostic server search procedure includes transmitting a vehicle identification request to a control communication node among the plurality of communication nodes when the predetermined diagnostic server search condition is satisfied by an edge communication node among the plurality of communication nodes; and
transmitting the message includes, after receiving the vehicle identification request,
including, by the control communication node, protocol support information of the control communication node in a message according to the diagnostic server search procedure, and
transmitting, by the control communication node, the message of the control communication node to the edge communication node, within a predetermined first time.

10. The method of claim 9, wherein:
the control communication node includes a control gateway and an electronic control module; and
transmitting the message includes
transmitting, by the control gateway, a third vehicle identification request to the electronic control module, and
after receiving the third vehicle identification request,
including, by the electronic control module, protocol support information of the electronic control module in a message according to the diagnostic server search procedure, and
transmitting, by the electronic control module, the message of the electronic control module to the control gateway, in the predetermined first time.

11. The method of claim 10, wherein:
transmitting the message further includes, after receiving a vehicle identification request from the edge communication node,
including, by the control gateway, protocol support information of the control gateway in a message according to the diagnostic server search procedure; and
transmitting, by the control gateway, the message of the control gateway to the edge communication node; and
the method further includes transmitting, by the control gateway, a third vehicle identification request to the electronic control module within a predetermined second time, after transmitting the message of the control gateway to the edge communication node.

12. The method of claim 1, further comprising:
waiting for reception of vehicle discovery by the one of the plurality of communication nodes, after transmitting the message, and
after receiving the vehicle discovery and satisfying the predetermined diagnostic server search condition, re-executing
i) performing the diagnostic server search procedure,
ii) including, in a message, protocol support information corresponding to whether a plurality of protocols including the first protocol can be supported, according to the re-executed diagnostic server search procedure, by the one of the plurality of communication nodes; and
iii) transmitting the message.

13. The method of claim 1, wherein:
the first protocol is based on Ethernet, and
including the protocol support information in the message comprises including the protocol support information in a further action of a message format according to a diagnostics over internet protocol (DoIP).

14. The method of claim 13, wherein:
the plurality of protocols comprise the first protocol based on Ethernet and a second protocol based on CAN; and
the protocol support information includes i) first protocol support information indicating that both the first and second protocols can be supported and ii) second protocol support information indicating that only the first protocol among the first and second protocols can be supported.

15. An apparatus for diagnostic communication in a vehicle, the apparatus comprising:
an edge communication node configured to receive a message from an external source of the vehicle and a protocol-converting or routing the message; and
a control communication node configured to receive the message protocol-converted or routed by the edge communication node,
wherein at least one of the edge communication node or the control communication node is configured to
perform a diagnostic server search procedure based on a first protocol, when a predetermined diagnostic server search condition is satisfied,
include, in a message, protocol support information corresponding to whether a plurality of protocols including the first protocol can be supported according to the diagnostic server search procedure, and
transmit the message.

16. The apparatus of claim 15, wherein the predetermined diagnostic server search condition includes a plurality of diagnostic server search conditions including at least two of:
a first condition in which at least one of the edge communication node or the control communication node is changed from a power-off state to a power-on state, or is physically disconnected;
a second condition in which the edge communication node receives a message according to a second protocol among the plurality of protocols from an external source of the vehicle; and
a third condition in which the edge communication node receives a first vehicle identification request from an external source of the vehicle, and
wherein at least one of the edge communication node or the control communication node is configured to perform the diagnostic server search procedure when at least one of the plurality of diagnostic server search conditions is satisfied.

17. The apparatus of claim 16, wherein:
the predetermined diagnostic server search condition includes the second condition and the third condition;
the first protocol is based on Ethernet;
the second protocol is based on controller area network (CAN);
the edge communication node is configured to, after receiving the first vehicle identification request,
transmit a message to an external source of the vehicle, and
transmit a second vehicle identification request to the control communication node; and
the control communication node is configured to, after receiving the second vehicle identification request,
include protocol support information of the control communication node in a message according to the diagnostic server search procedure, and
transmit the message of the control communication node to the edge communication node within a predetermined first time.

18. The apparatus of claim 15, wherein:
the edge communication node is configured to transmit a vehicle identification request to the control communication node when the predetermined diagnostic server search condition is satisfied, and
the control communication node is configured to, after receiving the vehicle identification request,
include protocol support information of the control communication node in a message according to the diagnostic server search procedure, and
transmit the message of the control communication node to the edge communication node, within a predetermined first time.

19. The apparatus of claim 18, wherein:
the control communication node comprises a control gateway and an electronic control module;
the control gateway is configured to transmit a third vehicle identification request to the electronic control module; and
the electronic control module is configured to, after receiving the third vehicle identification request,
include protocol support information of the electronic control module in a message according to the diagnostic server search procedure, and
transmit the message of the electronic control module to the control gateway, in the predetermined first time.

20. A vehicle comprising:
a computing device including a processor and a storage medium storing one or more programs executable by the processor,
wherein the one or more programs include instructions that, when executed by the processor, cause the processor to
perform a diagnostic server search procedure based on a first protocol when a predetermined diagnostic server search condition is satisfied by one of a plurality of communication nodes in the vehicle;
include, in a message, protocol support information corresponding to whether a plurality of protocols including the first protocol can be supported, according to the diagnostic server search procedure, by the one of the plurality of communication nodes; and
transmit the message.
